(19) United States
(12) Patent Application Publication
(10) Pub. No.: US 2019/0029297 A1
(43) Pub. Date: Jan. 31, 2019

(54) PLANT-DERIVED COLOURING TEXTURANTS

(71) Applicant: DUPONT NUTRITION, USA INC., Wilmington, DE (US)

(72) Inventors: Andrew KENDRICK, Hatton (GB); MAURICE GERARD LYNCH, WATERLOO (BE); ERMAN BIGIKOCIN, Burton upon Trent (GB)

(21) Appl. No.: 16/019,669

(22) Filed: Jun. 27, 2018

Related U.S. Application Data
(60) Provisional application No. 62/525,392, filed on Jun. 27, 2017.

(51) Int. Cl. A23L 5/44; A23L 29/231; A23L 21/12

(52) U.S. Cl. CPC A23L 5/44; A23V 2002/00; A23L 21/12; A23L 29/231

(57) ABSTRACT

The invention provides a plant-derived texturizing and colouring agent, said agent comprising a plant carotenoid pigment and pectin-containing fibrous plant matter, both of which have been recovered together from the same starting plant material, and an antioxidant, wherein the pectin-containing fibrous plant matter can impart texture to an aqueous composition, the carotenoid can impart colour to an aqueous composition and the antioxidant is present in an amount effective to prevent degradation of a substantial portion of the carotenoid thereby maintaining the colour of the agent. Methods of preparing the texturizing and colouring agent and the use of the same to texturise and colour foodstuff, beverage, pharmaceutical, nutraceutical, cosmetic or personal hygiene compositions are further provided.

### FIELD OF THE INVENTION

The present invention relates to plant-derived agents which are able to impart colour and texture to compositions of matter. More specifically the invention provides plant-derived texturizing and colouring agents comprising a natural plant carotenoid pigment and pectin-containing fibrous plant matter, both of which have been recovered together from the same starting plant material.

### BACKGROUND OF THE INVENTION

The replacement of artificial ingredients by natural alternatives is becoming increasingly important. Industry action is fuelled by the consumers' demand for natural food ingredients generally as well as by several scientific reports on the potential harmfulness of synthetic food dyes. Thus, there is a demand for natural texturizing agents and natural colouring agents. It has now been realised that it would be advantageous for a single natural ingredient to provide such properties, both from a cost and convenience perspective and also in order to keep the ingredients list of any commercial product as short as possible. The present inventors have now been able to develop such a dual purpose ingredient based on carotenoid pigments.

Natural colours, most often from plant sources, have been used to impart colour to various compositions, e.g. foodstuffs, beverages, cosmetics, personal hygiene products and pharmaceuticals. For instance carotenoids, e.g. carotenes, lutein and lycopene provide orange and yellow colours. In most instances, the primary extract from the source fruit or vegetable is a raw material which must undergo significant further formulation to make it suitable for specific food or beverage or other applications (WO 2018041730: WO 2016174004, WO 2003015537). WO 2016174004 describes colouring compositions comprising carotenoid pigment dispersed in an aqueous phase comprising polysorbate 80. WO 2003015537 describes colouring compositions comprising carotenoid pigment dispersed in the matrix comprising a pectin obtained from sugar beet.

Plant fibre-containing pectin preparations for use as texturizing agents have been provided previously, e.g. in WO2005/003178, WO2009/026936,GB1508993, US2015/0017316 and U.S. Pat. No. 5,567,462. These preparations are prepared by processes which do not set out to preserve the pigments present in the starting material to levels sufficient to act as a colouring agent and/or to maintain functional pigment for any appreciable length of time. As such, the preparations are not intended for, or suited for, use as dual purpose preparations that may both texturise and colour compositions of matter.

### SUMMARY OF THE INVENTION

The invention provides a plant-derived colouring and texturing agent comprising a pigment, typically a carotenoid and a pectin containing fibrous material in the presence of an antioxidant. The antioxidant is present at sufficient levels to prevent oxidative degradation of a substantial portion of the pigment or carotenoid. Accordingly, in one aspect the invention provides: a plant-derived texturising and colouring agent, said agent comprising a plant carotenoid pigment and pectin-containing fibrous plant matter, both of which have been recovered together from the same starting plant material, and an antioxidant, wherein the pectin-containing fibrous plant matter can impart texture to an aqueous composition, the carotenoid can impart colour to an aqueous composition, and the antioxidant is present in an amount effective to prevent degradation of a substantial portion of the carotenoid thereby maintaining the colour of the agent.

In another aspect the invention provides a method for preparing a plant-derived texturising and colouring agent, said agent comprising a plant carotenoid pigment and pectin-containing fibrous plant matter, wherein the pectin-containing fibrous plant matter can impart texture to an aqueous composition and the carotenoid pigment can impart colour to an aqueous composition, said method comprising;
(a) providing a naturally pigmented plant material containing a pectin and a carotenoid pigment,
(b) adjusting the pH of said plant material to equal to or above about pH 8 or equal to or below about pH 5 and incubating said plant material for a time and at a temperature which are sufficient to form a pectin-containing fibrous plant matter which can impart texture to an aqueous composition;
(c) recovering said pectin-containing fibrous plant matter and said carotenoid pigment; and
combining an antioxidant with the plant material and/or the texturising and colouring agent, thereby providing said texturising and colouring agent.

Additionally the invention provides a method of texturising and colouring a composition, said method comprising incorporating the plant-derived texturising and colouring agent of the invention into the composition under conditions suitable for the texturising and colouring properties of the agent to take effect.

Methods of preparing such dual purpose agents based on the acid and/or alkali treatment of plant material under conditions conducive to the retention of functional carotenoid pigments are also provided. The use of the plant-derived colouring texturants inter alia in foodstuffs, beverages, cosmetics, personal hygiene products and pharmaceutical compositions is further provided.

### BRIEF DESCRIPTION OF THE DRAWINGS

FIG. 1 is a photograph of a texturizing and colouring agent as prepared by the method of example 1 as compared to a similar agent prepared by the method of example 6.

FIG. 2 is a photograph of a jam composition coloured by the texturizing and colouring agent of the invention as described in example 8.

### DETAILED DESCRIPTION OF THE INVENTION

Unless otherwise specified all references cited herein are incorporated by reference in their entirety.

The following definitions may be used for the interpretation of the claims and specification:

As used herein, the terms “comprises,” “comprising,” “includes,” “including,” “has,” “having,” “contains” or “containing,” or any other variation thereof, are intended to cover a non exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The term “invention” or “present invention” as used herein is a non-limiting term and is not intended to refer to any single embodiment of the particular invention but encompasses all possible embodiments as described in the specification and the claims.

As used herein, the term “about” modifying the quantity of an ingredient or reactant of the invention employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities. In one embodiment, the term “about” means within 10% of the reported numerical value, preferably within 5% of the reported numerical value.

The invention provides a plant-derived colouring and texturing agent comprising a pigment, typically a carotenoid and a pectin containing fibrous material in the presence of an antioxidant. The antioxidant is present at sufficient levels to prevent oxidative degradation of a substantial portion of the pigment or carotenoid.

The fibre content of terrestrial plants is predominantly comprised of the polysaccharides cellulose, hemicellulose and pectin and the heterogeneous macromolecule lignin. Cellulose is a polymer of glucose monomers. Hemicellulose is a heterogeneous group of polysaccharides containing several kinds of hexose and pentose sugars (e.g. glucuronoxylan, arabinoxylan, glucomannan, and xyloglucan) and, in some cases, residues of uronic acids (e.g. glucuronic acid and galacturonic acid). These polymers are classified according to the type of sugar residues being dominant and are individually referred to as xylanes, arabinogalactans, glucomannans, glucuronoxylans, arabinoxylans, glucomannans, and xyloglucans etc.

Pectin is a polymer composed of a backbone(s) of α-D-galacturonic acid monomers attached by α-1,4-glycoside bonds to form long chains of polygalacturonic acid. The homogalacturonic regions may be interspersed with rhamnogalacturonic regions with 1,2 linked α-L-rhamnopyranosyl residues bearing different kinds and amounts of neutral sugar side chains. Neutral sugars, such as galactose, glucose, rhamnose, arabinose, apiose and xylose, may also be part of the pectin polymer as side-chains to or as members in the polygalacturonic acid chain.

The galacturonic acid units may be esterified with methanol to a varying degree and can be partly esterified with acetyl on the secondary hydroxyls. Non-esterified carboxyl groups may be partly or completely neutralised by one or more bases. An industrial distinction is thus made between high-methoxylated-pectin having a degree of esterification (DE) of greater than 50% and low-methoxylated-pectin having a degree of esterification of less than 50%. The degree of esterification is defined as the number of methyl-esterified galacturonic acid units expressed as a percentage of the total galacturonic acid units in the pectin molecule.

High methoxyl pectins are considered to be those with a DE above 50% form gels of the traditional jam type. Pectins of this type typically will only form gels at pH values below 3.8 and in presence of substances (e.g. soluble solids (sugars and the like) and/or solvents) that reduce water activity and thereby increase pectin to pectin interactions. Levels of sugar above 60% are generally employed for this function though the materials such as alcohol or glycerol could be used. High methoxyl pectins are primarily employed as gelling agents in preserves and confectionery foodstuffs. Low methoxyl pectins in which between 20 and 45% of the galacturonic acid residues are esterified with methanol typically can form gels over a wider range of pH values in the absence of sugar but require the presence of divalent (e.g. alkaline earth metal) ions. Low methoxyl pectins have been employed as gelling agents in low-sugar food products.

In pectin from some types of plant material, e.g. potatoes and sugar beets, a varying part of the galacturonic acid units may, in addition, have acetyl groups located on C-2 and C-3 positions, expressed as the degree of acetylation (DAc). DAc is defined, analogous to the degree of esterification, as the number of acetylated galacturonic acid units as a percentage of all galacturonic acid units.

Pectin exists in plant material alongside cellulose, hemicellulose and lignin as a component of an insoluble fibrous network which makes up plant cell walls and supporting structures. This insoluble form is refered to as protopectin. Restricted hydrolysis of the protopectin yields pectins.

Pectin and other plant fibres are commonly used as texturizing agents in foodstuffs, beverages, cosmetics, personal hygiene products, pharmaceuticals and other aqueous compositions. Pectin is able to provide texture on account of its ability provide viscosity in the presence of substances which reduce water activity (e.g. sugars), its ability to form gels at low pH (e.g. particularly at pH 3.8 and below) and/or in the presence of divalent cations (e.g. alkaline earth metal ions), its ability to interact with other pectin molecules in non-gelling conditions and its ability to act as a hydrocolloid stabiliser of aqueous compositions. Other plant fibres may act as texturizing agents on account of complex intermolecular interactions and the ability to act as hydrocolloid stabilisers of aqueous compositions.

The present invention therefore provides a plant-derived texturizing and colouring agent, said agent comprising a plant carotenoid pigment and pectin-containing fibrous plant matter, both of which have been recovered together from the same starting plant material, and an antioxidant, wherein the pectin-containing fibrous plant matter can impart texture to an aqueous composition, the carotenoid can impart colour to an aqueous composition and the antioxidant is present in an amount effective to prevent degradation of a substantial portion of the carotenoid thereby maintaining the colour of the agent.

The pectin-containing fibrous plant matter, the carotenoid and the antioxidant should be present in amounts and at a proportion sufficient to achieve both the effective colouring and texturizing of an aqueous composition. By effective colouring it is meant that the colour imparted is of a shade (hue) and intensity which is desired by the user and which may also be sufficiently stable to provide the desired colouring for the lifespan of the coloured composition.

The term “recovered together from the same starting plant material” is intended to reflect that the plant carotenoid pigment and pectin-containing fibrous plant matter are obtained/isolated contemporaneously from the same sample of starting plant material in a common process which involves fractionation of the plant material and removal of certain fractions and retention of others (including the plant carotenoid pigment and pectin-containing fibrous plant matter). The terms retained together from the same starting plant material, isolated together from the same starting plant material or obtained together from the same starting plant material may alternatively be used.

In certain embodiments the pectin-containing fibrous plant matter content of the texturizing and colouring agent is at least about 80%, e.g. at least about 85%, 90%, 95% or 99% (w/w) of the dry weight of the agent.

The pectin of the pectin-containing fibrous plant matter may be a pectin which can impart texture to an aqueous composition as part of the pectin-containing fibrous plant matter.

In certain embodiments the pectin content of the texturizing and colouring agent is at least about 5%, e.g. at least about 10%, 15%, 20%, 25%, 30%, 35%, 40%, 45%, 50%, 55%, 60%, 65%, 70%, 75%, 80%, 85%, 90% (w/w) of the dry weight of the agent. Any ranges which may be formed from any of these individual values are expressly contemplated.

In certain embodiments the non-pectin plant fibre content of the texturizing and colouring agent is at least 5%, e.g. at least about 10%, 15%, 20%, 25%, 30%, 35%, 40%, 45%, 50%, 55%, 60%, 65%, 70%, 75%, 80%, 85%, 90% (w/w) about 80% of the dry weight of the agent. Any ranges which may be formed from any of these individual values are expressly contemplated.

In certain embodiments the pigment content or carotenoid of the texturizing and colouring agent is at least about 0.01%, e.g. at least about 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1, 5%, 10%, 15% or 20% (w/w) of the dry weight of the agent. Any ranges which may be formed from any of these individual values are expressly contemplated. It will be apparent that the recited amounts apply to functional (non-degraded) forms of the pigment, i.e. molecules of the pigment which impart colour to an aqueous composition when comprised therein.

In certain embodiments the ratio of pigment (or carotenoid) to pectin-containing fibrous plant matter may be from 1:9000 to 1:1, e.g. 1:8000, 1:7000, 1:6000, 1:5000, 1:4000, 1:3000, 1:2000, 1:1000, 1:900, 1:800, 1:700, 1:600, 1:500, 1:400, 1:300, 1:200, 1:100, 1:90 1:80, 1:70, 1:50, 1:40, 1:30, 1:20, 1:10, 1:5, or 1:2.

In certain embodiments the ratio of pigment (or carotenoid) to pectin may be from 1:9000 to 1:1, e.g. 1:8000, 1:7000, 1:6000, 1:5000, 1:4000, 1:3000, 1:2000, 1:1000, 1:900, 1:800, 1:700, 1:600, 1:500, 1:400, 1:300, 1:200, 1:100, 1:90, 1:80, 1:70, 1:50, 1:40, 1:30, 1:20, 1:10, 1:5, or 1:2. Any ranges which may be formed from any of these individual ratios are expressly contemplated.

In certain embodiments the pectin of the texturizing and colouring agent of the invention has a degree of esterification (specifically methoxyl groups) of about 0 to about 80, e.g. about 0 to about 70, 60, 50, 40, 30, 20, 10, or 5, or about 1, 5, 10, 20, 30, 40, 50, 60, or 70 to about 80, e.g. 2-50, 2-45, 2-40, 5-50, 10-50, 10-40, or 15-35. Any ranges which may be formed from any of these range endpoints are expressly contemplated.

In certain embodiments the pectin of the texturizing and colouring agent of the invention has a degree of amidation of not more than about 95% e. g. a degree of amidation of not more than about 75%, 60%, 50%, 40%, 30%, 25%, or 20%. Any ranges which may be formed from any of these values are expressly contemplated.

In certain embodiments the pectin of the texturizing and colouring agent of the invention has a degree of acetylation of about 40 or less, e.g. a degree of acetylation of about, 30, 25, 20, 15, 10 or 5 or less. Any ranges which may be formed from any of these values are expressly contemplated.

In certain embodiments the texturizing and colouring agent of the invention is substantially, e.g. essentially, devoid of divalent cations, e.g. divalent alkali earth metal cations, e.g. calcium ions (Ca²⁺), magnesium ions (Mg²⁺), strontium ions (Sr²⁺) or barium ions (Ba²⁺). Expressed numerically the amount of divalent alkali earth metal cations in the texturizing and colouring agent of the invention is less than about 50 mmol/kg dry matter, e.g. less than about 40, 30, 25, 20, 15, 10, 5, 1 or 0.5 mmol/kg dry matter. Any ranges which may be formed from any of these values are expressly contemplated.

In accordance with the invention the pectin-containing fibrous plant matter of use in the texturizing and colouring agent is capable of imparting texture to an aqueous composition. More specifically, the pectin of use in the texturizing and colouring agent is capable of imparting texture to an aqueous composition as part of the pectin-containing fibrous plant matter. In the context of the invention “texturizing” encompasses, gelling, thickening (increasing viscosity) and stabilisation of an aqueous solution. The skilled person would be familiar with the routine tests available for measuring these properties. For instance, a commercially available texture analyser can be used to measure breaking strength of pectin induced gels and a rheometer can be used to analyse thickening properties such as viscosity of a pectin containing composition. Also rheometers can be further used to determine gel setting temperature, and gel setting time, of a pectin induced gel.

In certain embodiments the pectin-containing fibrous plant matter (or pectin) is capable of imparting texture to an aqueous solution comprising divalent alkali earth metal cations, e.g. Ca²⁺ or Mg²⁺, in particular Ca²⁺ ions, e.g. at concentrations equivalent to at least 4 mg Ca²⁺ per gram of pectin.

In other embodiments the pectin-containing fibrous plant matter (or pectin) is capable of imparting texture to an aqueous solution comprising a monosaccharide or a disaccharide (e.g. sucrose), e.g. at concentrations of at least about 25% w/v.

In these embodiments an aqueous solution may be a solution with a pH of about 1 to about 7, e.g. about 2, 3, 4, 5 or 6 to about 7, or about 1 to about 2, 3, 4, 5 or about 6, e.g. about 3. Any ranges which may be formed from any of these range endpoints are expressly contemplated.

The non-pectin plant fibre of the texturizing and colouring agent of the invention may comprise cellulose, hemicellulose, lignin or combination thereof. The precise content and make-up of this element of the texturizing and colouring agent of the invention will vary depending on the source plant material used.

The carotenoid pigment of the texturizing and colouring agent of the invention may be any carotenoid found (naturally occurring) in pectin-containing plant material in sufficient amounts to be recoverable from such material with pectin-containing fibrous plant matter, and functional derivatives (colour-retaining derivatives) thereof, in particular those which retain the colour of the natural carotenoid, which may be formed during recovery together with pectin-containing fibrous plant matter. Possible carotenoid pigments may therefore be, but are not limited to, α carotene, β carotene, lutein, lycopene, capsanthin, capsorubin, bixin and norbixin. In certain embodiments the carotenoid is not a carotenoid found in tomatoes, e.g. lycopene and in particular tomato lycopene.

The carotenoid pigment of the texturizing and colouring agent of the invention is capable of imparting a colour effectively to an aqueous composition, e.g. those which may be texturized by the pectin-containing fibrous plant matter of the texturizing and colouring agent of the invention. Thus, the pigment is a functional plant carotenoid molecule in that it absorbs certain wavelengths of visible light and reflects others. Preferably the carotenoid will have substantially the colour of the natural source when in an aqueous solution representative of its natural cellular environment (i.e. in the presence of equivalent ionic concentrations and pH). However, it will be recognised that isolated carotenoid pigments may show different colour hues and/or intensities under different chemical conditions and so in some embodiments the colour imparted by the carotenoid might not be the same as of its natural source. In these embodiments the colour of the carotenoid should be referenced to that of the same pigment freshly isolated from the same source under conditions designed to minimise degradation of the carotenoid molecule.

The carotenoid pigment of the texturizing and colouring agent of the invention is therefore substantially non-degraded as compared to the form of the carotenoid in the natural source, or at least any modifications as compared to the naturally occurring pigment do not result in substantial loss of expected colour hue and/or intensity or the ability to colour compositions effectively.

In other embodiments the texturizing and colouring agent of the invention may comprise a mixture of carotenoid pigments. In such embodiments the overall colour imparted by the composition will be a combination of the colours of the individual carotenoids. This may allow a wider variety of colours to be provided. In these embodiments the contribution of each carotenoid pigment to the overall colour should be assessed individually, if necessary, when considering the functionality of the carotenoids in the texturizing and colouring agent.

The plant material from which the carotenoid pigment and the pectin-containing fibrous plant matter of the texturizing and colouring agent of the invention are recovered may be any plant material which comprises sufficient amounts of pectin and the desired carotenoid pigment or combination thereof. Any such suitable material may come from any plant species, e.g. species within the mosses, the ferns, the palms, the conifers, the ginkgos, the monocots and the dicots. Within such groups, species of grass, legume, brassica and deciduous tree may provide convenient sources. The material may come from the whole plant or a part thereof, e.g. from the roots, rhizomes, fronds, stems, branches, leaves, needles, spines, seeds, seed pods, seed shells, bulbs, cones, fruits, berries, drupes, follicles, legumes, capsules, kernels, sporangiums, buds, husks, flowers, petals, carpels, stamens, stigmas, styles, anthers, filaments, bark and tendrils. Culinary fruits and/or vegetables, or parts thereof (e.g. skin, rind, husk, shell, core, pips or stone) may be used. Specific examples may be carrots (orange or yellow), pumpkin, pepper (paprika), gac fruit, achiote, mango, citrus fruits (e.g. lemon, orange, blood orange, pomello, lime, grapefruit), papaya, tomato and aubergine.

The amount of antioxidant effective to prevent degradation of a substantial portion of the carotenoid thereby maintaining the colour of the agent will typically be such that the pectin-containing fibrous plant matter and carotenoid pigment will require supplementation with exogenous antioxidant. Suitable antioxidants include, but are not limited to the tocopherols (vitamin E and related compounds), tocotrienols, ascorbic acid and salts thereof (e g. vitamin C) and its antioxidant derivatives (e.g. ascorbyl palmitate), rosemary extract, and other botanical extracts. In certain embodiments the antioxidant is not itself a carotenoid pigment. In certain embodiments the antioxidant is not a pigment. In certain embodiments the antioxidant is not a pectin or fragment or derivative thereof. In certain embodiments the antioxidant is not a plant fibre or fragment or derivative thereof. In certain embodiments the antioxidant is not recovered from the plant material together with the carotenoid and the pectin-containing fibrous plant matter. In other words the antioxidant is a separate component to the carotenoid and the pectin-containing fibrous plant matter of the texturizing and colouring agent of the invention.

In certain embodiments the antioxidant will be present in (added to) the texturizing and colouring agent of the invention in an amount of at least about 0.001%, e.g. at least about 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1, 5%, 10%, 15% or 20% (w/w) of the dry weight of the agent.

In certain embodiments the antioxidant is water soluble, e.g. ascorbic acid and salts thereof. Water soluble antioxidants can be considered to be antioxidants for which less than 500 parts pure water are required to solubilise 1 part of the antioxidant, e.g. less than 400, 300, 200, 100, 50, 40, 30, 20, 10, 9, 8, 7, 6, 5, 4, 3, 2 or 1 parts pure water are required to solubilise 1 part of antioxidant.

The term “prevent degradation of a substantial portion of the carotenoid thereby maintaining the colour of the agent” is intended to reflect that the antioxidant is present in an amount which preserves the carotenoid pigment in a functional form over a useful lifespan for the texturizing and colouring agent of the invention under suitable storage conditions, e.g. cool, dark and dry. Degradation of a small number of molecules might not prevented, but the amount of functional carotenoid pigment in the agent of the invention remains sufficient for the agent to effectively colour other compositions as described herein over a useful period of time.

It will be apparent to the skilled person that the texturizing and colouring agent of the invention is a product which has been processed from plant material and so is not a plant material in its natural state or a mechanically disrupted form thereof which retains essentially all of the components of the original plant material in unmodified form. The texturizing and colouring agent therefore may comprise reduced amounts of, e.g. insignificant amounts of, e.g. substantially or essentially no, water soluble flavours or free sugars (e.g. free mono- and di-saccharides, e.g. glucose, sucrose and/or fructose) from the starting plant material. Expressed numerically the texturizing and colouring agent of the invention comprises less than 20%, e.g. less than 15, 10, 5 or 1% water soluble flavours or free sugars

The texturizing and colouring agent of the invention may be substantially, e.g. essentially, dry, i.e. is substantially, e.g. essentially, water-free (moisture-free). This may be expressed as a water content of less than 30% w/w, e.g. less than 25, 20, 15, 12, 10, 9%, 8%, 7%, 6%, 5%, 4.5%, 4%, 3.5%, 3%, 2.5%, 2%, 1.5% or 1% w/w as measured by weight loss on drying or chemically by the Karl Fischer method (United States Pharmacopeia; European Pharmacopoeia). The dry texturizing and colouring agent of the invention may be in powder or particulate form.

The texturizing and colouring agent of the invention may further comprise excipients, fillers or diluents or functional additives to maintain the colouring and/or texturizing properties of the agent, e.g. preservatives (e.g. parabens, sorbic acid, salts of sorbic acid, benzoic acid, salts of benzoic acid) and pH adjusting agents (e.g. carboxylic acids and salts of carboxylic acids)

In another aspect the invention provides a method for preparing the texturizing and colouring agents of the invention based on the acid and/or alkali treatment of suitable plant material under conditions conducive to the retention and maintenance of functional carotenoid pigments.

More specifically the invention provides a method for preparing a plant-derived texturizing and colouring agent, said agent comprising a plant carotenoid pigment and pectin-containing fibrous plant matter, wherein the pectin-containing fibrous plant matter can impart texture to an aqueous composition and the carotenoid pigment can impart colour to an aqueous composition, said method comprising
(a) providing a naturally pigmented plant material containing a pectin and a carotenoid pigment,
(b) adjusting the pH of said plant material to equal to or above about pH 8 or equal to or below about pH 5 and incubating said plant material for a time and at a temperature which are sufficient to form a pectin-containing fibrous plant matter which can impart texture to an aqueous composition but which are not sufficient to cause substantial loss of pectin from the plant material and substantial degradation or loss of said pigment, and
(c) recovering said pectin-containing fibrous plant matter and said carotenoid pigment thereby providing said texturizing and colouring agent,
wherein an antioxidant is combined with the plant material and/or the texturizing and colouring agent.

The specific embodiments of the texturizing and colouring agent of the invention described above apply mutatis mutandis to the agents which may be prepared in accordance with the methods described herein.

The naturally pigmented plant material comprising pectin and the carotenoid pigment may be any of the plant material described above and may typically be fibrous.

The naturally pigmented plant material comprising pectin and the carotenoid pigment may be provided in any convenient form, e.g. dry, as a moist paste or as a wet slurry or suspension. The pigmented plant material may be prepared by the mechanical disruption of intact or partially intact water containing plant material. This disrupted product may have at least part of the liquid phase removed, e.g. by pressing, filtration or centrifugation. In other embodiments the pigmented plant material may be prepared by reconstituting dried plant material, e.g. powders or particulate forms thereof.

The naturally pigmented plant material containing a pectin and a carotenoid pigment may undergo further treatment prior to or after the pH adjustment step (step (b)). Such treatments may include thermal, e.g. heat (e.g. pasteurisation) treatments or enzymatic treatments.

Thermal treatments prior to of after the pH adjustment step may be advantageous, for instance to sterilise or pasteurise the plant material, to denature/deactivate enzymes (e.g. pectin and/or plant fibre degrading enzyme or pigment degrading enzymes) within the plant material and/or to break down or modify the physical structure of the plant material thereby increasing the amount of pectin available for modification upon pH adjustment.

Enzymatic treatments to de-esterify, deamidate or deacetylate pectin prior to (or following) the pH adjustment step may be used to further alter the texturizing properties of the pectin-containing fibrous plant matter and/or the pectin therein.

Enzymatic treatments which degrade lignin, cellulose, hemicellulose may improve efficiency of the process and/or yields and/or the texturizing properties of the pectin-containing fibrous plant matter and/or the pectin therein.

In certain embodiments, to the extent permitted by the carotenoid pigment in the naturally pigmented plant material, the pH of the material may be increased to at least about pH 8.0, e.g. at least about pH 8.5, 9.0, 9.5, 10.5, 11.0, 11.5, 12.0, 12.5, 13.0, 13.5 or 14.0, or about pH 8.0 to about pH 8.5, 9.0, 9.5, 10.5, 11.0, 11.5, 12.0, 12.5, 13.0, 13.5 or 14.0, or about pH 8.5, 9.0, 9.5, 10.5, 11.0, 11.5, 12.0, 12.5, 13.0, 13.5 to about pH 14.0. Any ranges which may be formed from any of these range endpoints are expressly contemplated.

In certain embodiments, to the extent permitted by the carotenoid pigment in the naturally pigmented plant material, the pH of the material may be decreased to no greater than about pH 5.0, e.g. no greater than about pH 4.5, 4.0, 3.5, 3.0, 2.5, 2.0, 1.5 or 1.0, or about pH 5.0 to about pH 4.5, 4.0, 3.5, 3.0, 2.5, 2.0, 1.5 or 1.0, or about pH 4.5, 4.0, 3.5, 3.0, 2.5, 2.0, 1.5 to about pH 1.0. Any ranges which may be formed from any of these range endpoints are expressly contemplated.

Increasing the pH of the naturally pigmented plant material to equal to or above about pH 8 may be achieved by any convenient means, e.g. combining said material with an alkali of sufficient strength or solution thereof. Suitable alkalis may include, but are not limited to basic inorganic alkali metal salts, e.g. inorganic salts of any of sodium (Na) and potassium (K), which when solubilised in water forms a basic solution, inorganic alkali earth metal salts, e.g. inorganic salts of any of magnesium (Mg) and calcium (Ca) which when solubilised in water forms a basic solution and ammonia. Hydroxides may conveniently be used. Depending on eventual application of the plant-derived texturizing and colouring agent of the invention the metal of the salt may be selected accordingly. For food applications the metal of the salt is preferably selected from sodium, potassium, calcium or magnesium, e.g. sodium hydroxide, potassium hydroxide, calcium hydroxide sodium carbonate and sodium bicarbonate. Bases which are not safe for human or animal consumption may be avoided.

Exposure of the naturally pigmented plant material to ammonia may affect the amidation profile of the pectin contained therein and so the use of these bases may be advantageous in certain embodiments. Conversely, use of ammonia might be avoided if additional amidation is to be minimised.

Adjusting the pH of pectin-containing plant material to equal to or above about pH 8 de-esterifies the pectin and thereby enhances its texturizing properties.

Lowering the pH of the pigmented plant material to equal to or below about pH 5 may be achieved by any convenient means, e.g. combining said material with an acid of sufficient strength or solution thereof. Suitable acids may include, but are not limited to, mineral acids (e.g. hydrochloric, sulphuric, nitric, phosphoric) and organic acids (e.g. acetic, citric, tartaric, malic, carbonic, sorbic, benzoic). Acids which are not safe for human or animal consumption may be avoided.

Adjusting the pH of pectin-containing naturally pigmented plant material to equal to or below about pH 5 may render the pectin molecules more available for gelling/thickening interactions and/or for binding cations from the pectin-containing plant material so formed (e.g. those cations which were present in the plant material or which may have been introduced during the method) thereby enhancing its texturizing properties. The treatment also serves to remove acid soluble substances which do not contribute to the functionality of the texturizing and colouring agent of the invention.

Incubation of the naturally pigmented plant material at the chosen pH may take place at any convenient temperature which does not result in the substantial degradation of the carotenoid pigment (loss of pigment function) at the chosen pH over the duration of the reaction. In certain embodiments the temperature is also selected so as to not to result in the degradation of the pectin, or at least significant amounts thereof, to fragments of a size which haves poor gelling/thickening properties and/or a size which are susceptible to loss from the pectin-containing fibrous plant matter.

In certain embodiments the temperature may be from about 0° C. to about 100° C., e.g. from about 0° C. to about 1, 2, 3, 4, 5, 10, 15, 20, 25, 30, 35, 40, 45, 50, 55, 60, 65, 70, 75, 80, 85, 90 or 95° C., or about 2, 3, 4, 5, 10, 15, 20, 25, 30, 35, 40, 45, 50, 55, 60, 65, 70, 75, 80, 85, 90 or 95° C. to about 100° C. Colder temperatures may be advantageous, at or above pH 8.0 , e.g. from about 0° C. to about 1, 2, 3, 4, 5, 10, 15, 20, 25° C. or about 2, 3, 4, 5, 10, 15, 20° C. to about 25° C. Any ranges which may be formed from any of these range endpoints are expressly contemplated.

Incubation of the pigmented plant material at the chosen pH and at the chosen temperature may take place for any time sufficient to form a pectin-containing fibrous plant matter which can impart texture to an aqueous composition (e.g. as defined above) under said incubation conditions of pH and temperature, but which does not result in the substantial degradation of the carotenoid pigment (and ideally also the pectin). Substantial degradation of the carotenoid pigment may be seen as a noticeable permanent loss of colour (e.g. loss of all colour or loss of the colour of the starting material, or the expected colour of the texturizing and colouring agent).

In certain embodiments this may be at least about 5 mins, e.g. at least about 10, 15, 20, 25, 30, 35, 40, 45, 50, 55, 60, 70, 80, 90, 100, 110, 120, 140, 160, 180, 210 or 240 mins. In other embodiments the duration of the incubation may be up to about 240 mins, e.g. up to 210, 180, 160, 140, 120, 110, 100, 90, 80, 70, 60, 55, 50, 45, 40, 35, 30, 25, 20, 15, 10 or about 5 mins. Any ranges which may be formed from any of these range endpoints are expressly contemplated. Shorter durations, e.g. at least about 5, 10, 15, 20, 25 or 30 mins may be preferable for the acid treatments.

During incubation of the pigmented plant material at the chosen pH it may be advantageous to control the solubility of the pectin in the plant material, e.g. so as to reduce loss of the pectin from the plant fibre. This may be achieved by controlling temperature and ionic strength, e.g. the concentration and/or the identity of the salts in the reaction mixture. More specifically the concentration of divalent cations, in particular divalent metal cations, should be controlled. It may be effective to include divalent cations, in particular divalent metal cations, and avoid pure water and to keep temperatures to a minimum. Substances which reduce water activity (e.g. mono- or disaccharides) may be included

In certain embodiments the pH adjustment and incubation step is repeated following a pH neutralisation step. In these embodiments the treated plant fibre may have a portion of the aqueous phase removed, e.g. by filtration, pressing, centrifugation or drying.

In certain embodiments it may be beneficial to employ a mechanical disruption means to the pigmented plant material. Non-limiting examples of mechanical disruption include are wet milling, and homogenization. As used herein “wet milling” will mean the use of a grinder, or some other mechanical particle reduction means such as used for example in rotor-stator configurated mills (such as but not limited to a colloid mill), or media mills such as a ball mill. As used herein “homogenization” process can be performed using an equipment designed for emulsification and/or dispersion, such as a high pressure homogenizer, or an ultrasonic disperser.

It will be seen by the skilled person that the references to the carotenoid pigment during the description of the methods of the invention are references to the carotenoid pigment (or carotenoid pigments) intended for the texturizing and colouring agent prepared in accordance with the invention, which may be referred to as the “target” carotenoid pigment. The starting naturally pigmented plant material should comprise a sufficient amount of the target carotenoid so as to result in a texturizing and colouring agent having the requisite amount of carotenoid pigment therein. The plant material may comprise other pigments, e.g. other carotenoid pigments, which are not targeted by the skilled person. Preservation of these non-target pigments need not be considered when selecting the various conditions of the method. Indeed, in certain embodiments conditions are selected to degrade non-target pigments. In certain embodiments the starting naturally pigmented plant material may therefore be selected on the basis that the predominant carotenoid pigment(s) therein provide a desired colour hue. In these embodiments it is these carotenoid pigments, i.e. those responsible for the colour hue of the naturally pigmented plant material, that are preserved (not substantially degraded) during the exercise of the method of the invention.

In certain embodiments in which the target carotenoid pigment is not degraded by either a pH above 8 or a pH below 5, the method of the invention may involve at least two alternating pH adjustment and incubation steps, e.g. the above-described alkali treatment followed by the above-described acid treatment or vice versa. Thus method of the invention may comprises a further step following step (b) and prior to step (c) in which, (i) if the pH of step (b) was equal to or below about pH 5, the pH of said plant material is adjusted to equal to or above about pH 8, or (ii) if the pH of step (b) was equal to or above about pH 8, the pH of said plant material is adjusted to equal to or below about pH 5.

In other embodiments there may be at least 3, e.g. at least 4, 5, 6, 8 or 10 cycles of alternating acid and alkali (or alkali and acid) treatments.

In other embodiments the alternating cycle may by interspaced with an alkali or and acid treatment step as described herein, e.g. for every alkali treatment step there are at least 2, 3, 4 or 5 acid treatment steps, or vice versa.

In these embodiments the pH of the incubation steps may be less extreme and/or treatment time and/or temperature may be lower. In these embodiments the treated plant material may have a portion of the aqueous phase removed, e.g. by filtration, pressing, centrifugation or drying, between one or more or each incubation and/or cycle.

In certain embodiments the method may comprise (or further comprise) an acid treatment step (e.g. as defined above) which removes at least a portion of any divalent cations, e.g. divalent metal cations, in the pectin-containing fibrous plant matter as the final incubation step (e.g. as defined above). This step may be repeated multiple times, e.g. at least 2, 3, 4 or 5 times with intervening steps of removing the aqueous phase, or portion thereof.

In these embodiments neutralisation of the acid washed pectin-containing fibrous plant matter may conveniently be performed with an alkaline salt comprising a cation which is not a divalent metal cation, e.g. an alkali metal salt (e.g. sodium or potassium bicarbonate or hydroxide). In embodiments in which neutralisation is not performed, a salt comprising a cation which is not a divalent metal cation, e.g. an alkali metal salt may be used (e.g. sodium or potassium chloride).

In certain embodiments the method may further comprise simple water washing steps at any suitable stage. The use of water with low ionic concentration, e.g. distilled/deionised forms may be advantageous. Washing may take place at multiple stages and at each stage in which washing takes place there may be multiple washing cycles. Washing may conveniently involve suspending (or resuspending) the pectin-containing fibrous plant matter, the pigmented plant material, or texturizing and colouring agent in water, optionally agitating or homogenising the suspension and then removing at least a portion of the aqueous phase, e.g. by filtration, pressing, centrifugation or drying. This process may be repeated. In other embodiments the washing water may be replaced or supplemented with a washing solution comprising salts and/or a pH buffer.

The texturizing and colouring agent prepared in accordance with the above-described method may undergo pH neutralisation with a suitable pH adjusting agent. In this context neutralisation refers to making the texturizing and colouring agent prepared in accordance with the above-described method more neutral, i.e. to give a pH closer to 7 or lower. Thus, in certain embodiments the pH of the texturizing and colouring agent prepared in accordance with the above-described method may be about 7 (e.g. pH 6.8 to 7.2), but in other embodiments the pH of the agent may be adjusted to be less than pH 8.0 and greater than pH 7.0, or greater than pH 5.0 and less than pH 7.0, or less than 6.5 or less than 6.0 or less than 5.5, where a preferred range is from about 3. 0 to about 5.0.

The antioxidant, e.g. those described above, may be combined with the pectin-containing fibrous plant matter, the pigmented plant material, or texturizing and colouring agent at any point, or any number of points, in the method (i.e. during or between any or all of steps (a), (b) or (c) or at multiple points during or between any or all of steps (a), (b) or (c)), e.g. in the above described amounts. Thus it may be included immediately prior to a pH adjustment step (e.g. the first if a plurality is used) to protect the carotenoid pigment during the acid/alkali treatments. In other embodiments it may be added multiple times, e.g. to replenish levels following its consumption in the acid/alkali treatments. In other embodiments the antioxidant is combined with the starting plant material or any or all of the above described pre-processing steps (e.g. during mechanical disruption and/or thermal or enzymatic treatment). In preferred embodiments the antioxidant may be added (further added) to the pectin-containing fibrous plant matter following the pH treatment step(s) and prior to or after any neutralisation step. Thus, in these embodiments the texturizing and colouring agent prepared in accordance with the method comprises an antioxidant, e.g. those described above, e.g. in an amount effective to prevent degradation of a substantial portion of the carotenoid thereby maintaining the colour of the agent, e.g. in the above described amounts.

In certain embodiments excipients, fillers or diluents or functional additives to maintain the colouring and/or texturizing properties of the agent, e.g. preservatives (e.g. parabens, sorbic acid, salts of sorbic acid, benzoic acid, salts of benzoic acid) and pH adjusting agents (e.g. carboxylic acids and salts of carboxylic acids) may be added to the pectin-containing fibrous plant matter following the pH treatment step(s) and prior to or after any neutralisation step. Neutralisation may be effected by the additional components.

In a specific embodiment the method of the invention comprises a method for the production of a plant-derived texturizing and colouring agent comprising:
(a) providing a naturally pigmented plant material containing pectin and a carotenoid pigment, wherein said material is yellow and/or orange carrot pulp,
(b) adjusting the pH of said carrot pulp to equal to about pH 12 with Ca(OH)₂ and incubating said plant material about 1 hour at about 5° C.,
(c) filtering the treated carrot pulp and resuspending the pulp in water,
(d) adjusting the pH of said carrot pulp to equal to about pH 1.3 with and incubating said plant material about 10 mins at about 22° C.,
(e) filtering the treated carrot pulp and resuspending the pulp in water,
(f) repeating steps (d) and (e) at least twice,
(g) washing the carrot pulp with deionised water until pH is about 3.0 to about 3.3,
(h) combing the carrot pulp with ascorbic acid to a final concentration of about 250 ppm
(i) recovering said pectin-containing fibrous plant matter and carotenoid pigment thereby providing said texturizing and colouring agent.

Alternatively, the invention provides a process where the plant material may be acidified prior to further processing as opposed to the alkaline treatment described above. As such in another aspect the invention provides a method for the production of a plant-derived texturizing and colouring agent comprising
a) providing a naturally pigmented plant material containing pectin and a carotenoid pigment, wherein said material is yellow and/or orange carrot pulp;
b) adjusting the pH of said carrot pulp to equal to about pH 2.0-2.1 with and incubating said plant material about 10 minutes at about 22° C. or room temperature;
c) filtering the treated carrot pulp and resuspending the pulp in water, where steps b) and c) may be repeated one or more times;
d) adjusting the pH of said carrot pulp to equal to about pH 2.9 and refiltering and resuspending the pulp in de-ionized water and readjusting the pH to about 2.8 with citric acid;
e) heating the pulp to about 75 C and held at that temperature for about 25 minutes;
f) cooling the pulp to room temperature and combining the mixture with a solution of ascorbic acid and Na-citrate where the pH is adjusted to 3.7 where the ascorbic acid is present at a concentration of about 1200 ppm; and
h) recovering said pectin-containing fibrous plant matter and carotenoid pigment thereby providing said texturizing and colouring agent.

The method of the invention may further comprise a step of removing water from the plant-derived texturizing and colouring agent. This may be achieved by any convenient means, e.g. by filtration, pressing, centrifugation or drying. Drying may include evaporation, freeze drying or spray drying. In certain embodiments the plant-derived texturizing and colouring agent is dried to a water content of less than 30% w/w, e.g. less than 25, 20, 15, 12, 10, 9%, 8%, 7%, 6%, 5%, 4.5%, 4%, 3.5%, 3%, 2.5%, 2%, 1.5% or 1% w/w as measured by weight loss on drying or chemically by the Karl Fischer method (United States Pharmacopeia; European Pharmacopoeia).

The dry texturizing and colouring agent of the invention may be in powder or particulate form. This may be achieved by applying appropriate spray drying techniques to the wet composition or by size reduction of the dry agent, e.g. by grinding or milling (e.g. in a ball or bead mill).

The invention further provides a plant-derived texturizing and colouring agent obtained or obtainable by the methods described herein.

The invention still further provides a method of texturizing and colouring a composition, e.g. a foodstuff, a beverage, a pharmaceutical, a nutraceutical, a cosmetic or a personal hygiene composition, said method comprising incorporating the plant-derived texturizing and colouring agent of the invention as described herein in the composition. The resultant composition should provide conditions suitable for the texturizing and colouring properties of the agent to take effect.

The invention therefore also provides a composition, e.g. a foodstuff, a beverage, a pharmaceutical, a nutraceutical, a cosmetic or a personal hygiene composition, obtained or obtainable by the methods described above.

The invention therefore also provides a composition, e.g. a foodstuff, a beverage, a pharmaceutical, a nutraceutical, a cosmetic or a personal hygiene composition, comprising the plant-derived texturizing and colouring agent of the invention as described herein. The composition should provide conditions suitable for the texturizing and colouring properties of the agent to take effect, e.g. as described above.

In the above compositions pectin (from the plant-derived texturizing and colouring agent of the invention) will be present in an amount of about 0.01% to 10% (w/w or w/v as appropriate), e.g. 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1, 5% to about 10% or about 0.02% to about 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1, 5% or about 10% (w/w or w/v as appropriate). Any ranges which may be formed from any of these range endpoints are expressly contemplated.

In the above compositions the carotenoid pigment (from the plant-derived texturizing and colouring agent of the invention) will be present in an amount of about 1 ppm to about 1000 ppm, e.g. about 50 ppm, 100 ppm, 150 ppm, 200 ppm, 250 ppm, 300 ppm, 350 ppm, 400 ppm, 450 ppm, 500 ppm, 550 ppm, 600 ppm, 650 ppm, 700 ppm, 750 ppm, 800 ppm, 850 ppm, 900 ppm or 950 ppm to about 1000 ppm, or about 50 ppm to about 100 ppm, 150 ppm, 200 ppm, 250 ppm, 300 ppm, 350 ppm, 400 ppm, 450 ppm, 500 ppm, 550 ppm, 600 ppm, 650 ppm, 700 ppm, 750 ppm, 800 ppm, 850 ppm, 900 ppm, 950 ppm or 1000 ppm. Any ranges which may be formed from any of these range endpoints are expressly contemplated.

The foodstuff may be selected from the group consisting of a milk product (such as yoghurt, butter, cream, butter milk, junket, milk jellies, ice cream, cheese or combinations thereof), a baked product (such as bread, rye bread, biscuit, tea-biscuit, cracker, piecrust, pate, patty and combinations thereof), a fruit or vegetable product (e.g. purees, sauces and toppings, jams, jellies, preserves, fruit butters and spreads, dessert products, juice based candies or gelatins, mixed juice products such as smoothies or yoghurts, diabetic, low carbohydrate and low calorie products, or dietary supplements containing juice) a meat or fish product (such as liver paste, sausages, meatballs, beef burger, fish cake, jellied fish (rollmops), cured meats, canned meats, pates, spreads), cereals, dressings e.g. for salads, a semi-manufactured product, pet food (e.g. dog or cat food), confectionary, prepared meals, a nutritional bar or a snack bar.

The beverage may be a fruit or vegetable juice, a milk or yoghurt drink, a non-dairy milk drink (e.g. almond, coconut, cashew or soy), an alcoholic drink (e.g. beer, wine or spirit based drinks, cocktails), a sports drink (e.g. electrolyte and/or high energy), a soda or a cordial and concentrates thereof.

Nutraceuticals may take any convenient food or beverage form, e.g. those described above.

The pharmaceutical may be in the form of any conventional galenic preparation, e.g. tablets, pills, powders (e.g. inhalable powders, including dry inhalable powders), lozenges, sachets, cachets, elixirs, suspensions, emulsions, solutions, syrups, aerosol media, sprays (e.g. nasal sprays), compositions for use in nebulisers, ointments, creams, salves, topical sprays, soft and hard gelatine capsules, suppositories, pessaries, sterile injectable solutions, sterile packaged powders, and the like.

The cosmetic may be a perfume, aftershave, eau de toilet, ointment, cream, lotion, balm, oil, butter, sunscreen, sunbloc, aftersun, artificial tan, moisturiser, exfoliant, facial mask, cleaser, toner, or make-up composition (e.g. concealer, primer, foundation, blusher, eyeliner, eyeshadow, lipstick, lip gloss, nail polish) make up remover, hair dye, hair wax, hair gel or hair cream.

The personal hygiene composition may be a soap, shower gel, shampoo, hair conditioner, deodorant, talc, hand wash, face wash, toothpaste or mouthwash.

The invention will be further described with reference to the following non-limiting Examples.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions.

### Example 1

### Preparation of a Texturizing and Colouring Agent from Orange Carrot

Carrots were chopped into discs and blanched in boiling water for 1 minute. The blanched carrot discs were then juiced and pulp was retained. The pulp was then cooled to 5° C., re-suspended in about 5 times weight of de-ionised water, and the pH was adjusted to and maintained at about pH12 using a slurry of 50% w/w Ca(OH)₂ in de-ionised water. The resulting mixture was incubated for 1 hour at 5° C. The mixture was then filtered and the retained pulp was re-suspended in about 5 times weight of de-ionised water, and the pH was adjusted to and maintained about pH1.3 for 10 minutes at room temperature (about 22° C.) using 18% v/v HCl solution in water. The mixture was then filtered to retain the pulp. This acid wash cycle was repeated twice. The acidified retained pulp was then washed with de-ionised water until the pH was the range from 3.0 to 3.3. The mixture was then filtered to retain the pulp. 25% w/v of ascorbic acid was mixed into the pulp until the final concentration of 250 ppm of ascorbic acid is achieved. The pH of the resulting mixture was increased to about 6.5 by adding powdered sodium bicarbonate. The neutralised mixture was dried and ground to a powder.

### Example 2

### Preparation of a Jam Composition that is Coloured and Texturised by use of a Dual Function Texturizing and Colouring Agent Prepared from Orange Carrot

The texturizing and colouring agent of Example 1 was used in the preparation of a jam in accordance with the following jam recipe (1000 grams batch size trial):

TABLE 2

| Ingredient | % w/w |
|---|---|
| Sucrose | 40 |
| Glucose syrup 42DE | 28 |
| Texturizing and colouring agent of Example 1 | 1 |
| 50% w/w citric acid solution | 0.48 |
| Water | 30.5 |
| Total | 100 |

Dry blend the texturizing and colouring agent of Example 1 with 3 times more sucrose.

Disperse the dry blend in water pre-heated to 100° C. and mix for 1 minute.

Pre-heated the glucose syrup to 90° C. and add into the mixture.

Add remaining sucrose into the mixture.

Heat the solution to 100° C. and mix until 67° Brix is achieved upon addition of 50% citric acid solution.

Hot fill the resulting mixture into containers, and rest the filled containers for natural cooling at room temperature (i.e. about 22° C.).

Final pH value was measured as 3.74. The gel strength of the Jam at about 4° C. was measured as 250 g by using Texture Analyser TA-XT2i (Stable Micro Systems) and 0.5 mm diamater cylindrical probe. The analysis conditions were 2.0 mm/s pre-test speed, 1.0 mm/s test speed, 2.0 mm/s post-test speed, and 15 mm distance.

In conclusion the 1% w/w dosage of the dual function ingredient provided a desirable spoonable structure where the product retained its shape after being spooned and a desirable colour appearance in the container (data not shown).

### Example 3

### Effects of Final pH on a Jam Composition that is Coloured and Texturised by Use of a Dual Function Texturizing and Colouring Agent Prepared from Orange Carrot

The jam composition recipe provided in Example 1 was used to create jams having about 64 to 66 Brix and different pH levels by varying the amounts of the citric acid solution and water added to the composition during its preparation. The resulting jam products of varying pH levels were analysed for gel strength at room temperature (i.e. about 22° C.) using the methodology described on Example 2. Results are shown in Table 3.

TABLE 3

| | | Gel | | |
|---|---|---|---|---|
| | | strength | Syner- | |
| pH | Brix | (g) | esis | Texture |
| 4.28 | 64 | n/a | none | short texture, viscous liquid form |
| 3.56 | 64 | 203.8 | none | gelled texture, spoonable and spreadable |
| 3.4 | 65 | 200.6 | none | gelled texture, spoonable and spreadable |
| 3.18 | 65 | 163.8 | none | gelled texture, spoonable and spreadable |
| 3.12 | 66 | 119.1 | none | gelled texture, spoonable and spreadable |

### Example 4

### Preparation of Calcium Induced Gel Composition that is Coloured and Texturised by Use of a Dual Function Texturizing and Colouring Agent Prepared from Orange Carrot

The texturing and colouring agent of Example 1 was used in the preparation of calcium induced gel in accordance with the following recipe (1000 grams batch size trial):

TABLE 4

| Ingredient | % w/w |
|---|---|
| Part 1 | |
| Texturizing and colouring agent of Example 1 | 2 |
| De-ionised water | 57 |
| Sucrose | 35 |
| Part 2 | |
| De-ionised water | 5.54 |
| Sodium hexametaphosphate | 0.22 |
| Calcium sulphate dihydrate | 0.24 |
| Total | 100 |

Dry blend the texturing and colouring agent of Example 1 with sucrose.

Disperse and dissolve the dry blend in water pre-heated to 100° C. and mix for 5 minutes to prepare Part 1.

Prepare the Part 2 by dissolving sodium hexametaphosphate in water pre-heated to 100° C., and then dissolve calcium sulphate dehydrate into the mixture.

Add Part 2 solution into the Part 1, and mix for 15 seconds.

Fill the resulting mixture into containers, and store the filled containers in chilled environment at about 4° C. for 18 hours.

The resulting mixture had 40° Brix and pH value of 6.07. At the end of the storage period at about 4° C., elastic and cuttable gels that do show syneresis were obtained. The gel strength at about 4° C. was measured as 809 g at 4.5 mm distance by using Texture Analyser TA-XT2i (Stable Micro Systems) and 25 mm diameter aluminium cylindrical probe. The analysis conditions were 2.0 mm/s pre-test speed, 1.0 mm/s test speed, 2.0 mm/s post-test speed, and 20 mm distance.

### Example 5

### Colour Measurement of a Model Composition that is Coloured by Use of a Dual Function Texturizing and Colouring Agent Prepared from Orange Carrot

The colouring effect of the texturizing and colouring agent of Example 1 was analysed in a preparation in accordance with the following recipe (500 grams batch size trial):

| Ingredient | % w/w |
|---|---|
| Texturizing and colouring agent of Example 1 | 1 |
| De-ionised water | 31 |
| Icing sugar | 68 |
| Total | 100 |

Disperse and dissolve the texturing and colouring agent of Example 1 in water pre-heated to 70° C. by using a high-shear mixer.

Disperse icing sugar into the mix.

Colour analysis in CIELab colour space was performed using ColorFlex EZ spectrophotometer (Hunterlab, USA) under a D65 light source, and reflectance readings of L*54.44, a*27.73, and b*37.48 were obtained.

### Example 6

### Preparation of a Texturizing and Colouring Agent from Orange Carrot in Absence of Antioxidant (Comparative Example)

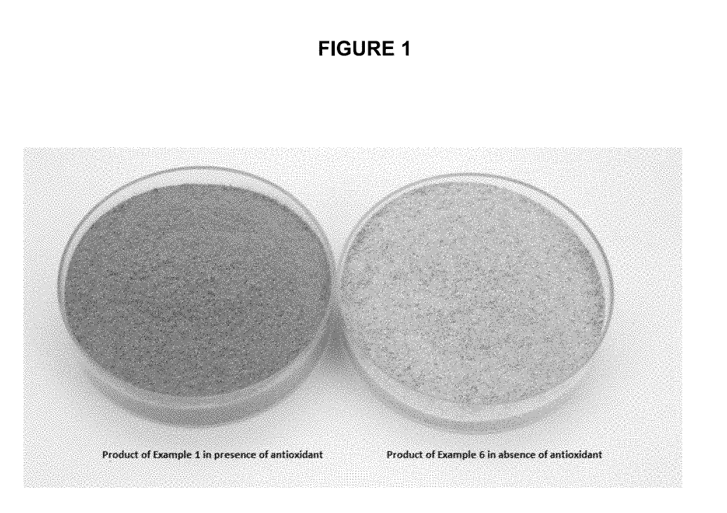

The preparation method described in Example 1 was followed excluding the step of ascorbic acid addition. The final products in powder form of Example 6 and Example 1 were stored in separate closed containers in dark room at ambient temperature for about 4 months. The product of Example 1 has retained the desirable colour shade as shown in FIG. 1.

### Example 7

### Preparation of a Texturizing and Colouring Agent from Orange Carrot

Chopped to disc and frozen carrots obtained from a local grocery store were defrosted at room temperature, and then juiced to obtain wet pulp. The wet pulp was suspended in about 6 times weight of de-ionised water, pH was adjusted to 2.0 to 2.1 range using 18% v/v HCl solution in water, and then stored for about 10 minutes at room temperature (about 22° C.). The mixture was then filtered to retain the pulp. This acid wash cycle at about pH 2.0 to 2.1 was repeated twice. The acidified retained pulp was then washed using de-ionised water until the pH of the suspension slurry was about 2.9. The mixture was filtered to retain the pulp. The retained pulp was then suspended into about 2 times weight of de-ionised water, and the pH of the suspension was adjusted to about 2.8 using 20% w/w citric acid solution. The mixture was then heated to 75° C., hold at this temperature for about 25 minutes, and then left to cool down to room temperature. 20% w/w ascorbic acid in water solution and 20% Na-citrate in water solution were mixed into the final mixture until the final concentration of ascorbic acid about 1200 ppm, and final pH about 3.70 were obtained. The mixture was then dried and ground to a powder. The pectin in the final product was analysed to have degree of esterification of 61%.

### Example 8

### Preparation of a Jam Composition that is Coloured and Texturised by Use of a Dual Function Texturizing and Colouring Agent Prepared from Orange Carrot

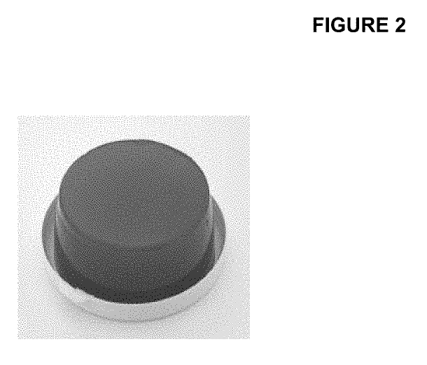

16 grams of texturizing and colouring agent of Example 7 was dry blended with 32 grams of sucrose, and then dispersed into 264 grams of water pre-heated to 90° C., and mixed for 3 minutes. 320 grams of sucrose was added into solution and mixed at about 90° C. for 3 minutes. 160 grams of glycose syrup (80% soluble solids content) pre-heated to 90° C. was added into the solution. Required quantity of 50% w/w citric acid solution was then mixed into the solution kept at 90° C. until pH of 3.0 was achieved and about 66° Brix was measured. The final mixture at 90° C. was filled into containers and then left for natural cooling at room temperature (about 22° C.). The containers were stored in a cold room at about 4° C. for about 18 hours. The containers were then moved to ambient environment until room temperature about 22° C. is achieved and jams in containers were then analysed for gel strength using Texture Analyser TA-XT2i (Stable Micro Systems). The gel strength of the jam at about room 22° C. was measured as 121 g using AOAC ½″ diameter cylindrical probe attachment and 0.5 mm/sec test speed. In conclusion, use of around 2% w/w of dual function ingredient provided set gel texture and desirable bright colour appearance as shown in FIG. 2.

1. A plant-derived texturising and colouring agent, said agent comprising a plant carotenoid pigment and pectin-containing fibrous plant matter, both of which have been recovered together from the same starting plant material, and an antioxidant, wherein the pectin-containing fibrous plant matter can impart texture to an aqueous composition, the carotenoid can impart colour to an aqueous composition, and the antioxidant is present in an amount effective to prevent degradation of a substantial portion of the carotenoid thereby maintaining the colour of the agent.

2. The plant-derived texturising and colouring agent of claim 1 wherein the carotenoid pigment content of the texturising and colouring agent is at least about 0.01%, (w/w) of the dry weight of the agent.

3. The plant-derived texturising and colouring agent of claim 1 wherein the pectin has a degree of esterification of about 0 to about 80.

4. The plant-derived texturising and colouring agent of claim 1 wherein the pectin has a degree of amidation of not more than about 25%.

5. The plant-derived texturising and colouring agent of claim 1 wherein the pectin has a degree of acetylation of about 40 or less.

6. The plant-derived texturising and colouring agent of claim 1 wherein the antioxidant is selected from the group consisting of a tocopherol, a tocotrienol, ascorbic acid or salts thereof, antioxidant derivatives of ascorbic acid, and antioxidant derivatives of rosemary extract.

7. The plant-derived texturising and colouring agent of claim 1 wherein the carotenoid pigment is selected from the group consisting of α carotene, β carotene, lutein, capsanthin, capsorubin, bixin and norbixin.

8. The plant-derived texturising and colouring agent of claim 1, wherein the plant material is selected from the group consisting of plant species within the mosses, the ferns, the palms, the conifers, the ginkgos, the monocots and the dicots.

9. The plant-derived texturising and colouring agent of claim 1 wherein the plant-derived texturising and colouring agent has a water content of less than 30% w/w.

10. A method for preparing a plant-derived texturising and colouring agent, said agent comprising a plant carotenoid pigment and pectin-containing fibrous plant matter, wherein the pectin-containing fibrous plant matter can impart texture to an aqueous composition and the carotenoid pigment can impart colour to an aqueous composition, said method comprising;
a) providing a naturally pigmented plant material containing a pectin and a carotenoid pigment,
b) adjusting the pH of said plant material to equal to or above about pH 8 or equal to or below about pH 5 and incubating said plant material for a time and at a temperature which are sufficient to form a pectin-containing fibrous plant matter which can impart texture to an aqueous composition
c) recovering said pectin-containing fibrous plant matter and said carotenoid pigment; and
d) combining an antioxidant with the plant material and/or the texturising and colouring agent, thereby providing said texturising and colouring agent.

11. The method of claim 10 wherein naturally pigmented plant material containing a pectin and a carotenoid pigment is provided in dry form, as a moist paste or as a wet slurry or suspension.

12. The method of claim 10 further comprising the additional step of;
(i) applying a mechanical disruption means to intact or partially intact water containing naturally pigmented plant material containing a pectin and a carotenoid pigment and optional removal of at least part of the liquid phase, or
(ii) reconstituting dried naturally pigmented plant material containing a pectin and a carotenoid pigment.

13. The method of claim 12 wherein mechanical disruption means is selected from the group consisting of wet milling, homogenization, and high pressure homogenization.

14. The method of claim 10 wherein the naturally pigmented plant material containing a pectin and a carotenoid pigment is subjected to a thermal treatment.

15. The method of claim 10 wherein the naturally pigmented plant material containing a pectin and a carotenoid pigment is subjected to an enzyme treatment.

16. The method of claim 10 wherein step (b) is repeated following a pH neutralisation step.

17. The method of claim 16 wherein the cycle of alternating acid treatment and alkali treatment steps is repeated for at least 3 cycles.

18. The method of claim 16, wherein a portion of the aqueous phase is removed between one or more of said acid treatment and alkali treatment steps and/or cycles thereof.

19. The method of claim 10 wherein the method comprises as the final incubation step an acid treatment step which removes at least a portion of any divalent cations in the pectin-containing fibrous plant matter.

20. A method for the production of a plant-derived texturizing and colouring agent comprising:
a) providing a naturally pigmented plant material containing pectin and a carotenoid pigment, wherein said material is yellow and/or orange carrot pulp;
b) adjusting the pH of the carrot pulp of step a) to about pH 12 with Ca(OH)₂ and incubating the pulp about 1 hour at about 5° C.;
c) filtering the treated carrot pulp of step b) and resuspending the pulp in water;
d) adjusting the pH of the carrot pulp of step c) to about pH 1.3 with and incubating the pulp for about 10 mins at about 22° C.;
e) filtering the treated carrot pulp of step d) and resuspending the pulp in water;
f) washing the carrot pulp of step e) with deionised water until pH is about 3.0 to about 3.3;
g) combining the carrot pulp of step f) with ascorbic acid to a final concentration of about 250 ppm; and
h) recovering the pulp of step g) containing a fibrous pectin and carotenoid pigment whereby a texturizing and colouring agent is produced.

21. The method of claim 20 wherein steps d) and e) are repeated one of more times.

22. A method for the production of a plant-derived texturizing and colouring agent comprising:
a) providing a naturally pigmented plant material containing pectin and a carotenoid pigment, wherein said material is yellow and/or orange carrot pulp;
b) adjusting the pH of the carrot pulp of step a) to about pH 2.0-2.1 with and incubating the pulp for about 10 minutes at about 22° C. or room temperature;
c) filtering the treated carrot pulp of step b) and resuspending the pulp in water;
d) adjusting the pH of said carrot pulp of step c) to about pH 2.9 and refiltering;
e) resuspending the pulp of step d) in de-ionized water and readjusting the pH to about 2.8 with citric acid;
f) incubating the pulp of step e) at about 75 C for about 25 minutes;
g) cooling the pulp of step f) to room temperature and combining it with a solution of ascorbic acid and Na-citrate where the ascorbic acid attains a concentration of about 1200 ppm and a pH of 3.7; and
h) recovering the treated pulp comprising fibrous pectin and carotenoid pigment wherein a texturizing and colouring agent is produced.

23. The method of claim 22 wherein steps b) and c) may be repeated one or more times.

24. A plant-derived texturising and colouring agent obtained by the method of claim 10.

25. A method of texturising and colouring a composition, said method comprising incorporating the plant-derived texturising and colouring agent of claim 1 into the composition under conditions suitable for the texturising and colouring properties of the agent to take effect.

26. (canceled)

27. (canceled)

28. (canceled)
